(19) United States
(12) Patent Application Publication
(10) Pub. No.: US 2002/0018324 A1
(43) Pub. Date: Feb. 14, 2002

(54) Ferromagnetic tunneling magneto-resistive head

(76) Inventors: Kenji Machida, Tokyo (JP); Naoto Hayashi, Tokyo (JP); Kazutoshi Mutou, Tokyo (JP); Toshihiro Uehara, Tokyo (JP); Morio Kondo, Atsugi-Shi (JP); Norio Hasegawa, Atsugi-Shi (JP); Hiroyuki Ujiie, Atsugi-Shi (JP); Akira Nakamura, Atsugi-Shi (JP)

Correspondence Address: Richard J. Streit, Ladas & Parry, Suite 1200, 224 South Michigan Avenue, Chicago, IL, 60604, US

(21) Appl. No.: 09/872,665

(22) Filed: Jun. 1, 2001

(30) Foreign Application Priority Data
Jun. 2, 2000 (JP) 2000-165747

(51) Int. Cl. G11B 5/39

(52) U.S. Cl. 360/324.2

(57) ABSTRACT

A ferromagnetic tunneling magneto-resistive head includes a first yoke, divided into a proximal portion and a distal portion across a gap; a second yoke formed so as to resist the first yoke, positioned opposite a magnetic recording medium, a read head gap being formed between the first and second yokes; a tunneling magneto-resistive element including at least one layer of insulating material, the insulating layer being sandwiched between at least two layers of magnetic material, the tunneling magneto-resistive element magneto-electrically converting a signal magnetic field applied via the first yoke and the second yoke by the recording medium making sliding contact with the read head gap; and a pair of electrodes positioned one at each end of the tunneling magneto-resistive element in a direction of layering of the magnetic layers. The tunneling magneto-resistive element is positioned so as to directly contact a proximal portion and a distal portion of the first yoke, with the read head gap, the proximal portion of the first yoke, the tunneling magneto-resistive element, the distal portion of the first yoke and the second yoke together forming an annular magnetic circuit.

### BACKGROUND OF THE INVENTION

1. Field of the Invention

The present invention relates generally to a ferromagnetic tunneling magneto-resistive head, and more particularly, to a ferromagnetic tunneling magneto-resistive head that converts a signal magnetic field recorded on a magnetic recording medium into an electrical signal by coming into sliding contact with the magnetic recording medium.

2. Description of the Related Art

Magnetic heads are widely used in magnetic recording/reproduction apparatuses in video recorders, tape recorders and external memory devices for computers. In recent years, with the need to record increasingly large amounts of data, magnetic recording apparatuses capable of accommodating high recording densities are sought.

Accordingly, the magnetic heads mounted on these types of magnetic recording/reproduction apparatuses also must be capable of reading data from and writing data to a magnetic recording medium at high recording densities. The recording density at which the magnetic head can read data from the recording medium is largely determined by the width of the magnetic head gap and the distance from the recording medium.

However, the conventional induction-type of magnetic head, in which a coil is wound around the magnetic core, is unsuited for reading and writing data to and from a recording medium at recording densities exceeding 20 Gbit per square inch, which is the level of recording density likely to be achieved in the not-too-distant future. One type of proposed high-density magnetic head capable of accommodating such high recording densities is the anisotropic magneto-resistive effect-type of magnetic head utilizing the anisotropic magneto-resistive effect, referred to below simply as an MR head.

FIGS. 1 and 2 show an example of a conventional MR head. FIG. 1 shows a lateral cross-sectional view of a conventional MR head. FIG. 2 shows a plan view of a conventional MR head.

The MR head shown in the diagrams is configured to use yokes 502, 503 to conduct a magnetic flux to the magneto-resistive sensor 504 from a magnetic recording medium 100, and is a so-called yoke-type MR head.

As shown in the diagrams, the yoke-type MR head comprises a non-magnetic substrate 501, atop which are disposed the first yoke 502 (that is, the lower yoke), the second yoke 503 (that is, the upper yoke), the MR sensor 504 and a sensor protective film 508. The first yoke 502 comprises a proximal portion 502a and a distal portion 502b. Similarly, the second yoke 503 comprises a proximal portion 503a and a distal portion 503b.

The first yoke 502 and the second yoke 503 are formed from a ferromagnetic material. Additionally, as can be seen in the diagrams, the proximal portion 503a and the distal portion 503b of the second yoke 503 are not continuous but are separated across a gap 505.

The MR sensor 504 is positioned below the gap 505 formed in the second yoke 503. Additionally, the MR sensor 504 is connected magnetically to the proximal portion 503a and the distal portion 503b of the second yoke 503. Further, the distal portion 502b of the first yoke 502 and the distal portion 503b of the second yoke 503 are joined and are thus connected magnetically. Additionally, a read gap 506 smaller than the gap 505 in the second yoke 503 is formed between the proximal portion 502a of the first yoke 502 and the proximal portion 503a of the second yoke 503.

As a result, the yoke-type MR head forms a magnetic circuit comprising the proximal portion 503a of the second yoke 503, the MR sensor 504, the distal portion 503b of the second yoke 503 and the first yoke 502, such that a signal flux from the magnetic recording medium 100 (for example, a magnetic tape) detected at the read gap 506 is conducted to the MR sensor 504 and converted to an electrical signal to obtain a reproduced output. It should be noted that the sensor protective film 508 is formed between the first yoke 502 and the second yoke 503 as well as above the second yoke 503 so as to protect the MR element 504 and the first and second yokes 502, 503.

However, the reproduced output of an MR head using an MR sensor 504 as described above increases proportionally to the width of the MR element 504, indicated in FIG. 2 by a double-headed arrow labeled Wmr. Additionally, the reproduced output of the MR head also increases with the extent to which the proximal portion 503a of the second yoke 503 and the distal portion 503b of the second yoke 503 and the MR sensor 504 overlap in a direction indicated in FIG. 2 by arrow X (hereinafter referred to as overlap width Ws). Accordingly, in order to increase the reproduced output of the MR head it is necessary to increase both the MR width Wmr and the overlap width Ws.

However, when using the conventional MR sensor 504 described above, increasing the MR width Wmr also increases the resistance of the MR sensor 504, so that the MR sensor 504 generates an increased amount of noise leading to read errors. In order to avoid this problem of noise, any increase in the width of the MR sensor 504 must be limited to no more than approximately 20 μm, but with such an arrangement it is impossible to obtain the desired high output.

Moreover, in order to obtain high reproduced output free from noise in the conventional yoke-type MR head, the sensor current flowing through the MR sensor 504 must be prevented from leaking to the proximal portion 503a of the second yoke 503 and the distal portion 503b of the second yoke 503 so that only the magnetic flux coming from the magnetic recording medium 100 is supplied to the MR sensor 504. As a result, in the conventional yoke-type MR head, an insulating layer 507 made of material having high relative resistance and high magnetic permeability is formed between the proximal portion 503a of the second yoke 503 and the MR sensor 504, and between the distal portion 503b of the second yoke 503 and the MR sensor 504.

However, in such a structure, it is difficult to select a suitably effective material for the insulating layer. In addition, it is necessary to form the insulating layer 507 at a point at which the proximal and distal portions 503a and 503b of the second yoke 503 overlap. Such a formation is difficult to accomplish successfully in view of the extremely small tolerances involved.

### BRIEF SUMMARY OF THE INVENTION

Accordingly, it is a general object of the present invention to provide an improved and useful ferromagnetic tunneling magneto-resistive head, in which the drawbacks described above are eliminated.

Another, further and more specific object of the present invention is to provide an improved and useful ferromagnetic tunneling magneto-resistive head capable of generating a high-output read signal.

The above-described objects of the present invention are achieved by a ferromagnetic tunneling magneto-resistive head comprising:

a first yoke, divided into a proximal portion and a distal portion across a gap;

a second yoke formed so as to resist the first yoke, positioned opposite a magnetic recording medium, a read head gap being formed between the first and second yokes;

a tunneling magneto-resistive element including at least one layer of insulating material, the insulating layer being sandwiched between at least two layers of magnetic material, the tunneling magneto-resistive element magneto-electrically converting a signal magnetic field applied via the first yoke and the second yoke by the recording medium making sliding contact with the read head gap; and

a pair of electrodes positioned one at each end of the tunneling magneto-resistive element in a direction of layering of the magnetic layers,

the tunneling magneto-resistive element positioned so as to directly contact a proximal portion and a distal portion of the first yoke,

the read head gap, the proximal portion of the first yoke, the tunneling magneto-resistive element, the distal portion of the first yoke and the second yoke forming an annular magnetic circuit.

According to this aspect of the invention, the tunnel MR element (hereinafter TMR element) is used as an element that converts a signal magnetic field recorded on the recording medium into an electrical signal. The TMR element has a high magneto-resistive variation rate, so a high reproduced output can be obtained even with high recording densities. The TMR element forms a magnetic circuit between the read head gap, the proximal portion of the first yoke, the distal portion of the first yoke, and the second yoke.

Additionally, the TMR element is disposed so as to directly contact edge surfaces of the proximal portion of the first yoke and the distal portion of the first yoke. As a result, the signal magnetic field flowing from the magnetic recording medium can be prevented from dropping between the proximal portion of the first yoke and the TMR element and between the TMR element and the distal portion of the first yoke. Accordingly, a high reproduced output can be obtained.

Additionally, the above-described objects of the present invention are also achieved by a ferromagnetic tunneling magneto-resistive head comprising:

a tunneling magneto-resistive element including at least one layer of insulating material, the insulating layer being sandwiched between at least two layers of magnetic material, the tunneling magneto-resistive element magneto-electrically converting a signal magnetic field to produce an output signal; and

a pair of electrodes positioned one at each end of the tunneling magneto-resistive element in a direction of layering of the magnetic layers,

the signal magnetic field being applied to the tunneling magneto-resistive element by the magnetic recording medium coming into direct sliding contact with the tunneling magneto-resistive element.

According to this aspect of the invention, the tunnel MR element (hereinafter TMR element) is used as an element that converts a signal magnetic field recorded on the recording medium into an electrical signal. The TMR element has a high magneto-resistive variation rate, so a high reproduced output can be obtained even with high recording densities.

Additionally, the magnetic recording medium is in direct sliding contact with the TMR element, so the signal magnetic field recorded on the magnetic recording medium can be applied directly to the TMR element. As a result, the signal magnetic field loss can be held to a minimum, so a high reproduced output can be obtained.

Moreover, the TMR element is sandwiched between a pair of electrodes at both ends in a direction of layering of the magnetic layers, so the pair of electrodes act as a reinforcing member reinforcing the TMR element. As a result, wear on the TMR element can be prevented even when the magnetic recording medium is in direct sliding contact with the TMR element.

### BRIEF DESCRIPTION OF THE DRAWINGS

These and other objects, features, aspects and advantages of the present invention will become better understood and more apparent from the following description, appended claims and accompanying drawings, in which:

FIG. 1 shows a lateral cross-sectional view of a conventional MR head;

FIG. 2 shows a plan view of a conventional MR head;

FIG. 3 shows a vertical cross-sectional view of a ferromagnetic TMR head according to a first embodiment of the present invention;

FIG. 4 shows a plan view of the TMR head according to the first embodiment of the present invention;

FIG. 5 shows an expanded lateral cross-sectional view of the TMR sensor of the TMR head according to a first embodiment of the present invention, along the lines X1-X1 in FIGS. 3 and 4;

FIG. 6 shows a lateral cross-sectional view of a TMR head according to a first variation of the first embodiment of the present invention;

FIG. 7 shows a lateral cross-sectional view of a TMR head according to a second variation of the first embodiment of the present invention;

FIG. 8 is a graph showing change in resistance with TMR element size;

FIG. 9 is a graph showing a relation between head efficiency on the vertical axis and, on the horizontal axis, a proportion between Ws (the width of the connection of the proximal portion 102a of the first yoke 102 to the TMR element 104) and Wu (optical read track width);

FIG. 10 shows a vertical cross-sectional view of a ferromagnetic TMR head according to a second embodiment of the present invention;

FIG. 11 shows a plan view of the TMR head according to the second embodiment of the present invention;

FIG. 12 shows a perspective view of the TMR head according to the second embodiment of the present invention;

FIG. 13 shows a perspective view of a TMR head according to a first variation of the second embodiment of the present invention;

FIG. 14 is a lateral cross-sectional view of a TMR head according to a second variation of the second embodiment of the present invention; and

FIG. 15 is a lateral cross-sectional view of a TMR head according to a third variation of the second embodiment of the present invention.

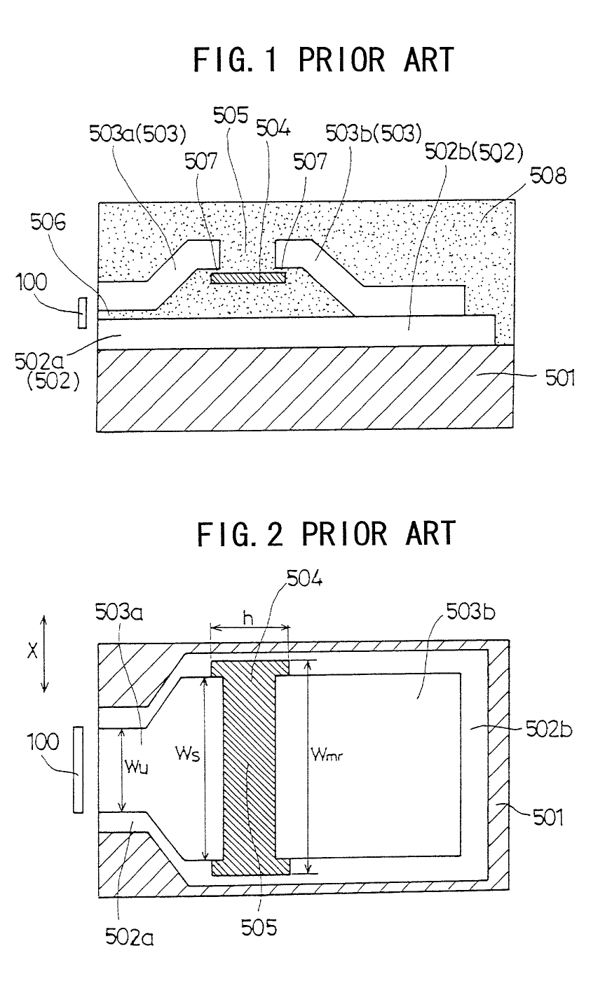

### DETAILED DESCRIPTION OF THE INVENTION

A description will now be given of a magnetic head apparatus according to one embodiment of the present invention, with reference to the accompanying drawings. It should be noted that identical or corresponding elements are given identical or corresponding reference numbers in all drawings.

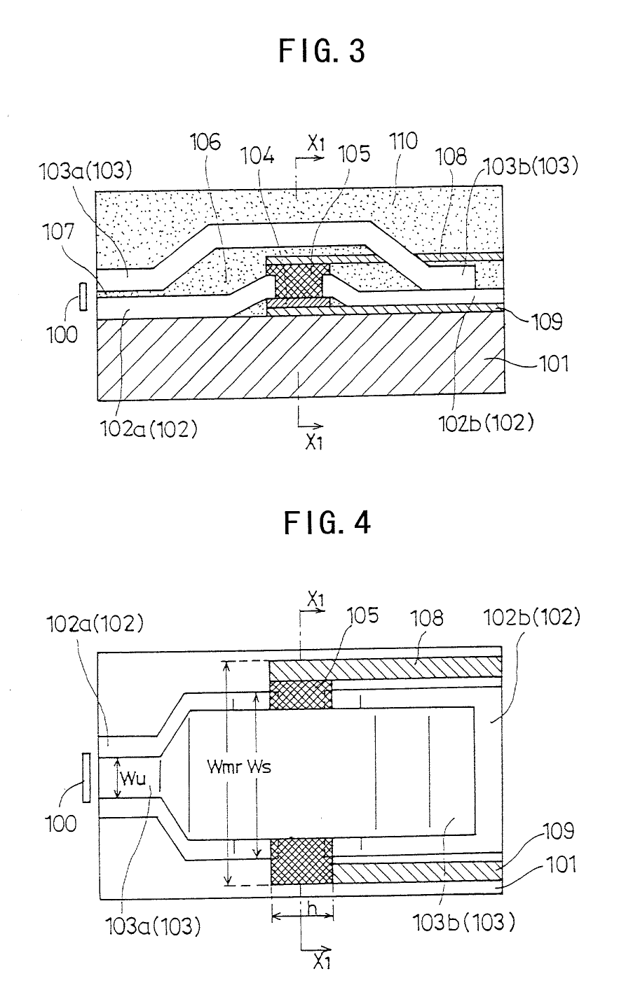

A description will now be given of a magnetic head according to a first embodiment of the present invention, with reference to the accompanying drawings, in the first instance FIGS. 3 and 4.

FIG. 3 shows a vertical cross-sectional view of a ferromagnetic TMR head according to a first embodiment of the present invention. FIG. 4 shows a plan view of the TMR head according to the first embodiment of the present invention.

By slidingly contacting a magnetic recording medium 100, the TMR head according to the first embodiment of the present invention converts a signal magnetic field recorded on the magnetic recording medium 100 into an electrical signal. Additionally, the TMR head according to the first embodiment of the present invention applies the signal magnetic field recorded on the magnetic recording medium 100 to a TMR element 104.

A description will now be given of the constituent elements of the TMR head described above.

As shown in the diagrams, the TMR head comprises chiefly a substrate 101, a first yoke 102, a second yoke 103, the TMR element 104, an upper electrode 105 and a lower pullout electrode 109, and as such is a yoke-type magnetic head.

The first yoke 102 comprises a proximal portion 102a and a distal portion 102b. The second yoke 103 similarly comprises a proximal portion 103a and a distal portion 103b. Both the first yoke 102 and the second yoke 103 are composed of a ferromagnetic material.

Additionally, the proximal portion 102a of the first yoke 102 and the distal portion 102b of the first yoke 102 are separated across a gap. The TMR element 104 is provided below the gap formed between the proximal portion 102a of the first yoke 102 and the distal portion 102b of the first yoke 102. As can be appreciated by those skilled in the art, the TMR element 104 is magnetically connected to the proximal portion 102a of the first yoke 102 and the distal portion 102b of the first yoke 102.

Specifically, a predetermined portion of what is shown in FIG. 3 as the right side of the proximal portion 102a of the first yoke 102 overlaps the TMR element 104. Similarly, a predetermined portion of what is shown in FIG. 3 as the left side of the distal portion 102b of the first yoke 102 overlaps the TMR element 104. As a result of such a configuration, the TMR element 104 is in direct contact with the proximal portion 102a of the first yoke 102 and the distal portion 102b of the first yoke 102.

Further, the distal portion 102b of the first yoke 102 and the distal portion 103b of the second yoke 103 are joined, and are thus connected magnetically. Additionally, a slight gap that is a read gap 107 is formed at the proximal end between the proximal portion 102a of the first yoke 102 and the proximal portion 103a of the second yoke 103.

As a result, the TMR head forms a magnetic circuit between the first yoke 102 (the proximal portion 102a of the first yoke 102), the proximal portion 103a of the second yoke 103, the TMR element 104 and the second yoke 103 (the proximal portion 103a of the second yoke 103, the distal portion 103b of the second yoke 103). The signal magnetic flux from the magnetic recording medium 100 (for example magnetic tape) detected at the read gap 107 is then applied to the TMR element 104 via the proximal portion 102a of the first yoke 102, where the signal magnetic flux is converted into an electrical signal (a read signal). The reproduction signal so generated is then output externally via the upper pullout electrode 108 and the lower pullout electrode 109. It should be noted that the element protective film 110 is formed atop the gap 106 formed between the first yoke 102 and the second yoke 103, as well as atop the second yoke 103, and serves to protect the TMR element 104, the first and second yokes 102, 103 and the electrodes 108, 109.

A description will now be given of the structure of the TMR sensor 104.

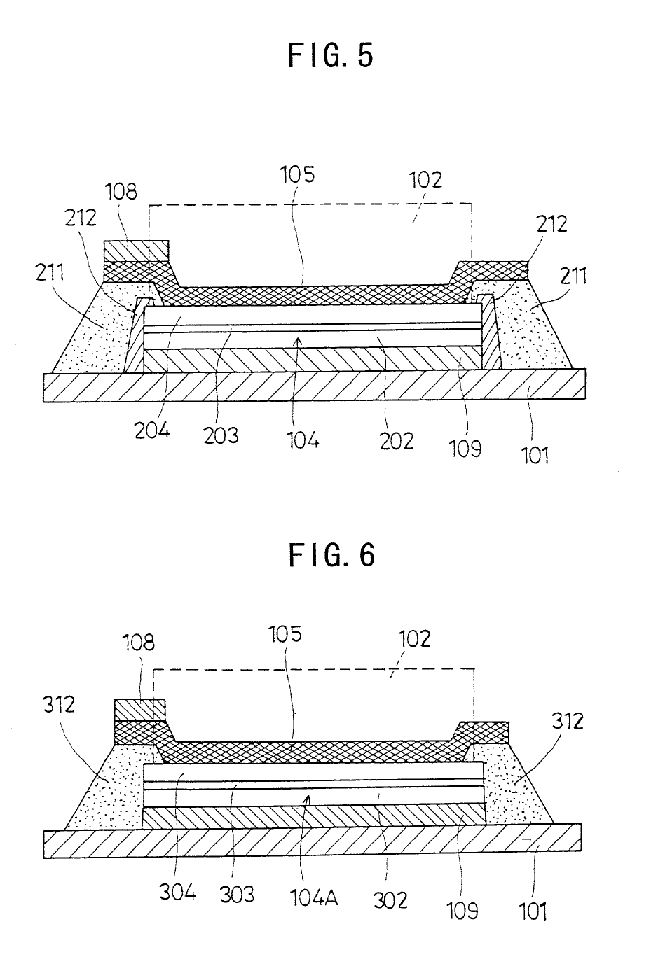

FIG. 5 shows an expanded lateral cross-sectional view of the TMR sensor of the TMR head according to a first embodiment of the present invention, along the lines X1-X1 in FIGS. 3 and 4.

The TMR sensor 104 has at least one layer of insulating material atop a substrate 101, with that insulating layer sandwiched between two or more magnetic layers. For illustrative purposes only, the TMR sensor 104 used in the present embodiment, as shown in FIG. 5, uses a single insulating layer indicated by reference numeral 203.

Additionally, the TMR element 104 is formed atop the lower pullout electrode 109, which in turn is formed atop the substrate 101. The TMR element 104 is composed of the first magnetic layer 202, the insulating layer 203 and the second magnetic layer 204.

At this time, the first magnetic layer 202 and the second magnetic layer 204 are electrically insulated so that no electrical currents other than a tunnel current flows therebetween. In order to achieve this state of insulation, the insulating layer must have a thickness of from 1 nm to 2 nm.

Additionally, the first magnetic layer 202 is fixedly magnetized in one direction, and must be formed of a material that does not change its direction of magnetization when exposed to different external magnetic fields. In order to achieve such a structure, the first magnetic layer 202 may be made solely of a hard magnetic material magnetized in one direction, or it may be made of layers of antimagnetic film and soft magnetic film.

By contrast, the second magnetic layer 204, that is, the free magnetic layer, is formed of a material that changes direction instantaneously upon exposure to an external magnetic field. Additionally, a hard bias film 211 is formed at both lateral ends of the second magnetic layer 204 to apply a bias magnetic field to the second magnetic layer 204 in order to stabilize changes in the direction of magnetization of the second magnetic layer 204.

It should be noted that, for purposes of illustration only, the hard bias film 211 used in the present embodiment is made of CoPt. However, as can be appreciated by those of skill in the art, the hard bias film 211 can be made of any electrically conductive magnetic material. Accordingly, in order to ensure that the first magnetic layer 202 and the second magnetic layer 204 are not electrically conductive therebetween, the hard bias film 211 is formed after the insulating film 212 is already formed at both ends of the TMR element 104.

The proximal portion 102a and the distal portion 102b that together form the first yoke 102, by contacting the TMR 104 as described above, are magnetically connected to each other. More specifically, the first yoke 102 contacts the second magnetic layer 204 (that is, the free magnetic layer) of the TMR element 104. In other words, the second magnetic layer 204 directly contacts proximate edge portions of the proximal portion 102a of the first yoke 102 and the distal portion 102b of the first yoke 102. As a result of such a configuration, the signal magnetic field from the magnetic recording medium 100 is applied directly to the second magnetic layer 204 (that is, the free magnetic layer).

Specifically, the signal magnetic field of the magnetic recording medium is first conducted to the first yoke 102 (that is, the proximal portion 102a of the first yoke 102) and then applied via the first yoke 102 to the TMR element 104. In the structure described above with respect to the present embodiment, the signal magnetic field from the magnetic recording medium 100 is first applied to the second magnetic layer 204 of the TMR element 104.

As a result, the second magnetic layer 204 remains unaffected by the insulating layer 203 of the TMR element 104 and the remaining magnetic layer 202 of the TMR element 104, and the change in the direction of magnetization corresponds accurately to the signal magnetic field characteristics applied from the magnetic recording medium 100 via the first yoke 102. Accordingly, in the structure according to the present embodiment described above, the TMR head reproduction characteristics can be improved.

The upper electrode 105 is formed atop the TMR sensor 104 having the structure described above. The upper pullout electrode 108 is connected to the upper electrode 105. At this time, the resistance between the upper pullout electrode 108 and the lower pullout electrode 109 is 50Ω.

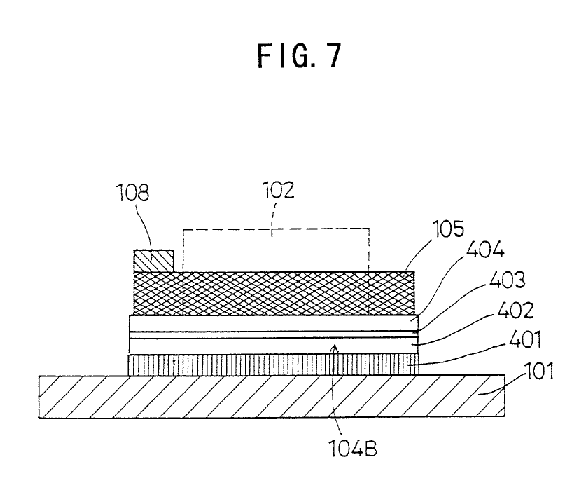

A description will now be given of a variation of the TMR head shown in FIG. 5, with reference to FIG. 6 and FIG. 7.

FIG. 6 shows a lateral cross-sectional view of a TMR head according to a first variation of the first embodiment of the present invention. FIG. 7 shows a lateral cross-sectional view of a TMR head according to a second variation of the first embodiment of the present invention.

The TMR head shown in FIG. 6, like the TMR head shown in FIG. 5, has a TMR head element 104A comprising a first magnetic layer 302, an insulating layer 303 and a second magnetic layer 304. However, in the present variation the hard bias film 312 uses a magnetic material such as Co—Fe2-O4 or Ba—Fe12-O19, which have a high relative resistance. By employing such high relative resistance material as the hard bias film 312, the present variation permits the elimination of the insulating film required by the structure shown in FIG. 5, thus allowing the TMR head to be simplified.

The TMR head shown in FIG. 7, like the TMR head shown in FIG. 5, has a TMR element 104B that comprises a first magnetic layer 402, an insulating layer 403 and a second magnetic layer 404. However, by employing a magnetic material that is electrically conductive, such as a CoPt combination, for the lower pullout electrode 401, the TMR head according to the present embodiment equips the lower pullout electrode 401 with the function of the hard bias film.

Therefore, with the TMR head according to the present variation, the magnetic field leaking from the hard bias film/lower electrode applies a bias to the second magnetic film 404. With such a structure, the hard bias films 211, 312 and insulating film 212 required by the TMR heads shown in FIGS. 5 and 6 can be eliminated, thus further simplifying the structure of the TMR head.

A description will now be given of a read operation of the TMR head according to the embodiment shown in FIGS. 3 through 5.

The TMR head according to the present embodiment as described above slides along the magnetic recording medium 100 to generate a reproduction signal. Information in the form of a digital signal is magnetically recorded on the magnetic recording medium 100, such that when the magnetic recording medium 100 slides relative to the TMR head, the signal magnetic field magnetically recorded on the magnetic recording medium 100 enters the proximal portion 102a of the first yoke 102 via the read gap 107.

The signal magnetic field entering the proximal portion 102a of the first yoke 102 is then applied to the second magnetic layer 204 of the TMR element 104 that bridges the proximal portion 102a of the first yoke 102 and the distal portion 102b of the first yoke 102. In so doing, the second magnetic layer 204 is magnetized in a direction that corresponds to the signal magnetic field.

Next, the signal magnetic field entering the TMR element 104 is led to the distal portion 103b of the second yoke 103, to return to the magnetic recording medium 100 through the second yoke 103 (that is, the proximal portion 103a of the second yoke 103 and the distal portion 103b of the second yoke 103), thus forming an annular magnetic circuit within the TMR head. At this point, the resistance of the TMR element 104 changes according to the relative angle formed between the direction of magnetization of the first magnetic layer 202 of the TMR element 104 and the direction of magnetization of the second magnetic layer 204 of the TMR element 104.

As described above, the upper electrode 105 is provided atop the upper surface of the TMR element 104. The upper pullout electrode 108 is connected to the upper electrode 105. Additionally, the lower pullout electrode 109 is connected to the lower surface of the TMR element 104. Accordingly, an electric current flows between the upper pullout electrode 108 and the lower pullout electrode 109 and, by referring to the voltage change generated between the electrodes the digital signal information recorded on the magnetic recording medium 100 can be detected.

The present embodiment uses the TMR element 104 as a sensor that converts the signal magnetic field recorded on the magnetic recording medium 100 into an electrical signal. The TMR element 104 can provide a-high read output even with high recording densities. Additionally, the TMR element 104 is directly connected to edge surfaces of the proximal portion 102a of the first yoke 102 and the distal portion 102b of the first yoke 102. As a result, a drop in the signal magnetic field flowing from the magnetic recording medium 100 between the proximal portion 102a of the first yoke 102 and the TMR element 104, and between the TMR element 104 and the distal portion 102b of the first yoke 102, making it possible to achieve high reproduced output.

However, the resistance value of the TMR element 104 used in the present embodiment as described above is related to the size of the TMR element 104. Additionally, a larger resistance of the TMR element 104 means a larger heat level, causing an apparent drop in reproduced output.

As a result, in the present embodiment as described above, the size of the TMR element 104 is set so that the resistance of the TMR element 104 is no more than 50Ω, thus reducing thermal agitation noise.

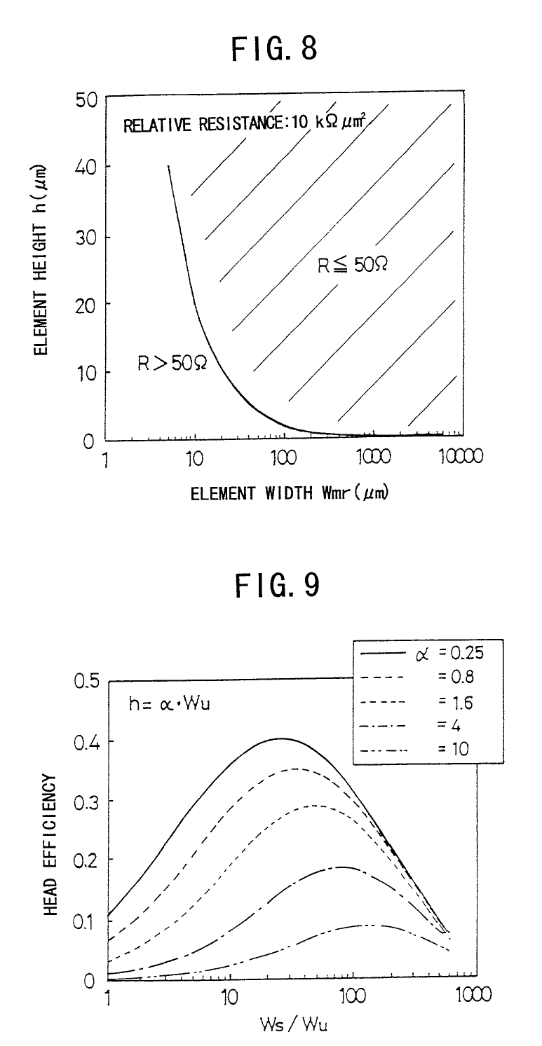

FIG. 8 is a graph showing change in TMR element resistance with TMR element size. The graph shows a region in which the resistance of the TMR element 104 is no more than 50Ω in relation to a TMR element 104 width Wmr and height h, assuming a TMR element relative resistance of 10 KΩμm². The MR read amp noise level is approximately −180 dBV/ √Hz. In order to not exceed this level, the TMR element 104 resistance must not exceed 50Ω. Accordingly, assuming a relative resistance of the TMR element 104 of 10 KΩ μm², then the width Wmr of the TMR element 104 and the height h of the TMR element must be set so that the resistance R≦50 Ω.

Additionally, in determining the size of the TMR element 104, the requirements for a high-output TMR head must be taken into consideration.

FIG. 9 is a graph showing a relation between head efficiency on the vertical axis and, on the horizontal axis, a proportion between Ws (the width of the connection of the proximal portion 102a of the first yoke 102 to the TMR element 104) and Wu (optical read track width).

The use of the proportion Ws/Wu on the horizontal axis is to check the head efficiency. Additionally, the inclusion of the formula h=α·Wₛ in the diagram, in the upper left corner of the graph is to show the relation to head efficiency of the relation between a width of the TMR element 104 in a direction perpendicular to the sliding surface of the magnetic recording medium 100 (indicated by arrow h in FIG. 2) and the optical read track width Wu, limited by a coefficient α.

When examined in light of the considerations described above, the graph shown in FIG. 9 gives the logical head efficiency when the coefficient α is varied from 0.25 to 10. Thus, for example, when the coefficient α=0.25, the ratio Ws/Wu peaks in the vicinity of 25, so a maximum head efficiency of approximately 0.4 can be obtained. To take another example, when the coefficient α=10, the ratio Ws/Wu peaks in the vicinity of 130, so a maximum head efficiency of approximately 0.08 is obtained. In short, as the coefficient α increases, the head efficiency α decreases.

In order to reproduce the signal magnetic fields recorded at high density on the magnetic recording medium 100 so as to obtain a satisfactory reproduction signal, the head efficiency must be at least 0.05. Accordingly, in order to satisfy such a requirement, the coefficient a must be 10 or less. Additionally, as described above, the formula h=α·Wₛ is rewritten as α=h/Wₛ. As a result, the condition that “the coefficient α must be α≦10” be rewritten as “the width h of the TMR element 104 in a direction perpendicular to the sliding surface of the magnetic recording medium 100 must be no more than 10 times the optical read track width Wₛ”.

That is, by selecting a TMR element 104 size such that the width h of the TMR element 104 in a direction perpendicular to the sliding surface of the magnetic recording medium 100 is no more than 10 times the optical read track width Wₛ, a reproduced output fir the signal magnetic field recorded on the magnetic recording medium 100 can be securely obtained. In light of these conditions, the present embodiment employs the following dimensions: Insulating layer 203 thickness of 2 nm, Wu=5 μm, Wmr=50 μm, Ws=48 μm, h=4 μm.

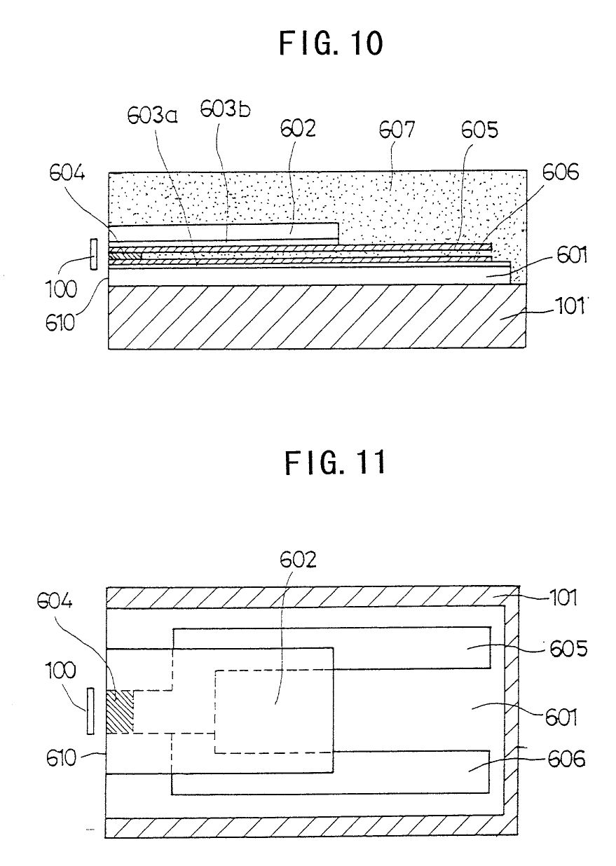

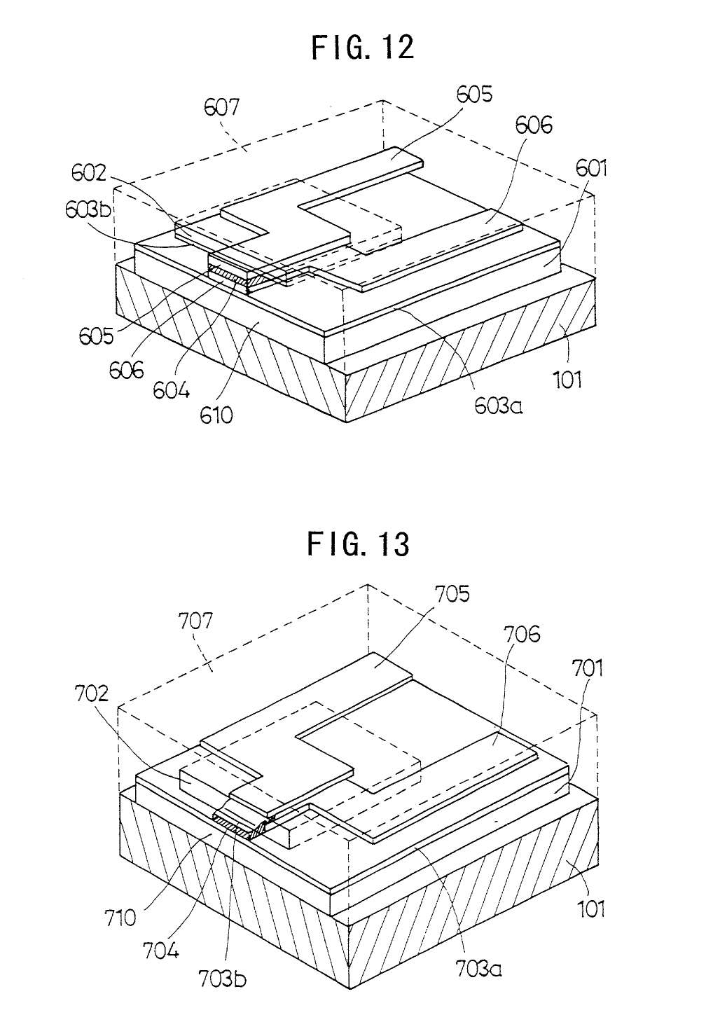

A description will now be given of a magnetic head according to a second embodiment of the present invention, with reference to the accompanying drawings, in the first instance FIG. 10, FIG. 11 and FIG. 12.

FIG. 10 shows a vertical cross-sectional view of a ferromagnetic TMR head according to a second embodiment of the present invention. FIG. 11 shows a plan view of the TMR head according to the second embodiment of the present invention. FIG. 12 shows a perspective view of the TMR head according to the second embodiment of the present invention.

In contrast to the TMR head according to the first embodiment of the present invention as described above, the TMR head according to the second embodiment of the present invention does not make use of yokes 102, 103 or their equivalent. Instead, the TMR head according to the second embodiment of the present invention directly slides a TMR element 604 against the magnetic recording medium 100, and is thus a so-called shield-type magnetic head structure.

The TMR head according to the second embodiment of the present invention chiefly comprises a substrate 101, a lower magnetic shield film 601, an upper magnetic shield film 602, a TMR element 604, an upper electrode 605 and a lower electrode 606.

As with the TMR head according to the first embodiment of the present invention as described above, the substrate 101 is a nonmagnetic or magnetic substrate. On a top portion of the substrate 101 are formed the following, in order: The lower magnetic shield film 601, a lower insulating film 603a, the lower electrode 606, the TMR element 604, the upper electrode 605, an upper insulating layer 603b, and the upper magnetic shield film 602. Thus the TMR element 604 is sandwiched between the upper electrode 605 and the lower electrode 606. Further, an element protective film 607 made of nonmagnetic material is provided both atop the upper magnetic shield film 602 and the upper electrode 605 as well as in a space between the upper electrode 605 and lower electrode 606.

Additionally, in the TMR head according to the second embodiment of the present invention, the TMR element 604 is exposed to the sliding contact surface 610 of the magnetic recording medium 100. As a result, when the TMR head comes into sliding contact with the magnetic recording medium 100, the signal magnetic field recorded on the magnetic recording medium 100 is applied directly to the TMR element 604. As a result, the TMR head according to the second embodiment of the present invention can reduce the signal magnetic field loss generated by the yokes 102 and 103 necessary to the structure of the TMR head according to the first embodiment of the present invention as described above, thus making higher reproduced outputs obtainable.

Additionally, as shown in FIGS. 10, 11 and 12, and as described above, the TMR element 604 is positioned between the electrodes 605, 606, so despite being in direct sliding contact with the magnetic recording medium 100 frictional wear on the TMR 604 can be prevented.

Though not employed in the present embodiment, those skilled in the art will appreciate that the sliding contact surface 610 of the magnetic recording medium 100 may be curved as well as polished in order to improve sliding contact between the magnetic recording medium 100 and the TMR head.

However, in the case of the TMR head according to the second embodiment of the present invention as described above, the read gap width is the distance separating the upper magnetic shield 602 and the lower magnetic shield 601. Yet in the TMR head according to the present embodiment the upper and lower electrodes 605, 606 sandwich and completely cover the TMR 604, so as shown in FIG. 12 the read gap length is the sum of the thicknesses of the lower insulating layer 603a, the lower electrode 606, the TMR element 604, the upper electrode 605 and the upper insulating layer 603b. The result is that the read gap width is increased and as a consequence the ability to reproduce high-density recordings may be degraded.

A description will now be given of a TMR head according to a first variation of the second embodiment of the present invention as described above with reference to FIGS. 10, 11 and 12, with reference to FIG. 13.

FIG. 13 shows a perspective view of a TMR head according to a first variation of the second embodiment of the present invention.

The TMR head according to the first variation of the second embodiment of the present invention has as its object to remedy the problem of expanded read gap as described above. Upper and lower electrodes 705, 706 provided above and below a TMR element 704 are positioned behind the TMR element 704, in contact with a rear edge of the TMR element 704. As a result, the upper and lower electrodes 705, 706 can be kept from the magnetic recording medium 100 and the sliding contact surface 710.

As a result, according to the first variation of the second embodiment of the present invention as described above, the relatively thick upper and lower electrodes 705, 706 are not exposed to the magnetic recording medium 100 and sliding contact surface 710. Thus, the read gap width becomes only the sum of the lower insulating layer 703a, the TMR element 704 and the upper insulating layer 703b, and accordingly the read gap can be narrowed over that of the TMR head shown in FIG. 12.

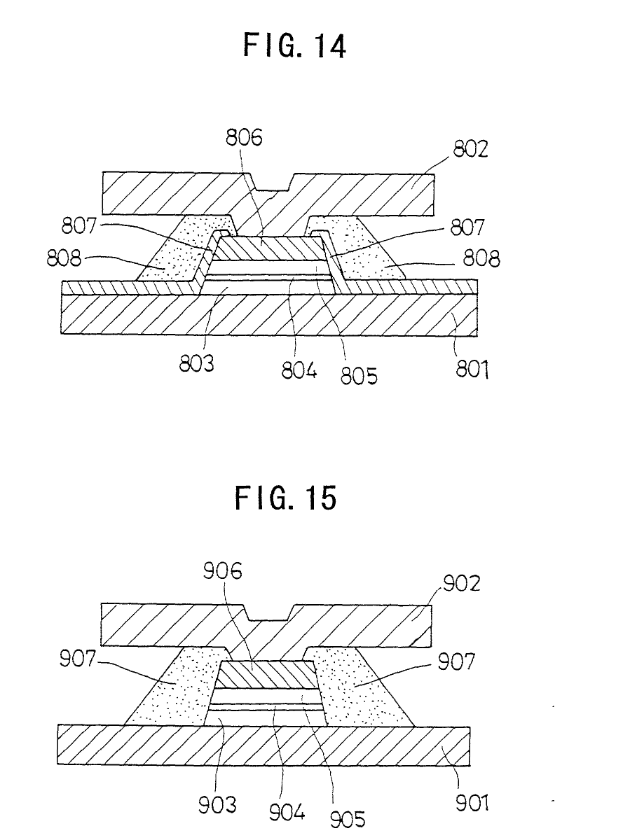

A description will now be given of a TMR head according to a second variation and a third variation of the second embodiment of the present invention as described above, with reference to FIG. 14 and FIG. 15, respectively.

FIG. 14 is a lateral cross-sectional view of a TMR head according to a second variation of the second embodiment of the present invention. FIG. 15 is a lateral cross-sectional view of a TMR head according to a third variation of the second embodiment of the present invention. It will be noted that in both variations the upper and lower magnetic shields also function as upper and lower electrodes, respectively.

The TMR head according to the second variation of the second embodiment, shown in FIG. 14, comprises a lower magnetic shield film (that is, a lower electrode) 801, atop which are formed a first magnetic layer 803, an insulating layer 804, a second magnetic layer 805 and a read gap width adjustment film 806, in that order. In terms of narrowing the read gap width, the read gap width adjustment film 806 must be made of a nonmagnetic material. In terms of functioning as an electrode, the read gap width adjustment film 806 must be made of an electrically conductive material.

Additionally, the first magnetic layer 803 and second magnetic layer 805 that together form the TMR element must be completely insulated. If, however, the hard bias film 808 is made of an electrically conductive material such as CoPt, and if the hard bias film 808 is directly formed to both ends of the first magnetic layer 803 and the second magnetic layer 805, then the first and second magnetic layers 803, 805 become conductive.

As a result, in the TMR head according to the present embodiment, an insulating film 807 is preformed at edge portions of the first magnetic layer 803 and the second magnetic layer 805, as well as at a bottom of the hard bias film 808. It should be noted that the insulating film 807 must be made extremely thin and provide effective insulation so as not to interfere with the effect generated by the hard bias film 808.

Additionally, the TMR head according to the third variation of the second embodiment, shown in FIG. 15, is characterized by the use of a material that is magnetic but not electrically nonconductive (such as, for example, Co—Fe2-O4 or Ba—Fe12-O19) for the hard bias film 907. When such a material is used for the hard bias film 907, the first magnetic layer 903 and the second magnetic layer 905 do not need to be covered by an insulating film, thus simplifying the process of producing the TMR head.

Further, in the TMR head shown in FIGS. 10 and 12, electrodes or insulating film are provided between the upper and lower magnetic shields, thus complicating the narrowing of the read gap to suitable proportions for high-density recording reproduction. However, with the TMR head shown in FIGS. 14 and 15, the upper and lower magnetic shields also function as upper and lower electrodes, so that by changing the thickness of the respective read gap width adjustment films 806, 906 the read gap can be adjusted to a desired width.

Additionally, the thin film magnetic head of the present invention can also be used with the shield-type MR head as well, so that by conducting the magnetic flux directly from the magnetic recording medium to the TMR element without passing through a yoke the effectiveness of the head can be improved over that of the yoke-type MR head, with increased reproduced output. Those skilled in the art will appreciate that there is the additional advantage that, depending on the TMR element film composition, the read gap can be narrowed with comparative ease as well.

As can be appreciated by those skilled in the art, the TMR heads according to the above-described embodiments and variations thereof, though formed as dedicated read heads only, can be made into a read/write head by forming a coil in the gap 106 between the first yoke 102 and the second yoke 103 shown in FIG. 3. Additionally, in the case of a shield-type MR head as well, by using for example the upper magnetic shield film 602 of FIG. 10 as the lower magnetic pole of the recording head and forming a thin film recording head atop thereof, the head can be converted into a read/write head.

The above description is provided in order to enable any person skilled in the art to make and use the invention and sets forth the best mode contemplated by the inventors of carrying out the invention.

The present invention is not limited to the specifically disclosed embodiments and variations, and modifications may be made without departing from the scope and spirit of the present invention.

The present application is based on Japanese Priority Application No. 2000-165747, filed on Jun. 2, 2000, the entire contents of which are hereby incorporated by reference.

What is claimed is:

1. A ferromagnetic tunneling magneto-resistive head comprising:
a first yoke, divided into a proximal portion and a distal portion across a gap;
a second yoke formed so as to resist the first yoke, positioned opposite a magnetic recording medium, a read head gap being formed between the first and second yokes;
a tunneling magneto-resistive element including at least one layer of insulating material, the insulating layer being sandwiched between at least two layers of magnetic material, the tunneling magneto-resistive element magneto-electrically converting a signal magnetic field applied via the first yoke and the second yoke by the recording medium making sliding contact with the read head gap; and
a pair of electrodes positioned one at each end of the tunneling magneto-resistive element in a direction of layering of the magnetic layers,
the tunneling magneto-resistive element positioned so as to directly contact a proximal portion and a distal portion of the first yoke,
the read head gap, the proximal portion of the first yoke, the tunneling magneto-resistive element, the distal portion of the first yoke and the second yoke forming an annular magnetic circuit.

2. The ferromagnetic tunneling magneto-resistive head as claimed in claim 1, wherein at least one of the two or more layers of magnetic material of the tunneling magneto-resistive element is a free magnetic layer that changes its direction of magnetization depending on the signal magnetic field emanating from the magnetic recording medium, the free magnetic layer directly contacting the proximal portion of the first yoke and the distal portion of the first yoke.

3. The ferromagnetic tunneling magneto-resistive head as claimed in claim 1, wherein a width of the tunneling magneto-resistive element in a direction perpendicular to a surface of the magnetic recording medium is no more than 10 times as long as an optical reproduction track width Wu of the head.

4. The ferromagnetic tunneling magneto-resistive head as claimed in claim 1, wherein the electrical resistance across the pair of electrodes is no more than 50Ω

5. A ferromagnetic tunneling magneto-resistive head comprising:
a tunneling magneto-resistive element including at least one layer of insulating material, the insulating layer being sandwiched between at least two layers of magnetic material, the tunneling magneto-resistive element magneto-electrically converting a signal magnetic field to produce a reproduction signal; and
a pair of electrodes positioned one at each end of the tunneling magneto-resistive element in a direction of layering of the magnetic layers,
the signal magnetic field being applied to the tunneling magneto-resistive element by the magnetic recording medium coming into direct sliding contact with the tunneling magneto-resistive element.
